(19) United States
(12) Patent Application Publication
(10) Pub. No.: US 2025/0382548 A1
(43) Pub. Date: Dec. 18, 2025

(54) DETERGENT FORMULATION USING NON-IONIC SURFACTANT AND POLYMER AGGREGATES

(71) Applicants: Jiuyuan Chen, Austin, TX (US); Yubin Chen, Houston, TX (US)

(72) Inventors: Jiuyuan Chen, Austin, TX (US); Yubin Chen, Houston, TX (US)

(21) Appl. No.: 19/239,497

(22) Filed: Jun. 16, 2025

Related U.S. Application Data
(60) Provisional application No. 63/660,507, filed on Jun. 15, 2024.

(51) Int. Cl. C11D 1/72; C11D 1/66; C11D 1/825; C11D 3/22; C11D 3/37

(52) U.S. Cl. CPC C11D 1/72; C11D 1/662; C11D 1/8255; C11D 3/222; C11D 3/3723; C11D 2111/12

(57) ABSTRACT

A method, and a detergent formulation for forming a micelle in order to enhance non-ionic surfactant detergency performance includes a primary non-ionic surfactant, a polymer blended with or bonded to the primary non-ionic surfactant to form a primary non-ionic surfactant-polymer aggregate. The primary non-ionic surfactant includes an ethoxylated alcohol. The polymer is selected from the group consisting of cellulose, polyethyleneimine ethoxylate, and alkoxylated polyethyleneimine. The detergent formulation includes a secondary non-ionic surfactant mixed with the primary non-ionic surfactant-polymer aggregate. The secondary non-ionic surfactant includes one of Lauryl glucoside, octyl glucoside, and sorbitan. The primary non-ionic surfactant-polymer aggregate and said secondary non-ionic surfactant are in a ratio ranging from 10:1 to 1:20. The detergent formulation forms a micelle structure in an aqueous environment to provide detergency. The detergent formulation has application in various cleaning products, including laundry detergents, dishwashing liquids, and surface cleaners.

### CROSS-REFERENCE TO RELATED APPLICATIONS

The present application claims priority to U.S. Provisional Application No. 63/660,507, filed Jun. 15, 2024; all of which is incorporated herein in its entirety and referenced thereto.

### BACKGROUND OF THE INVENTION

### Field of the Invention

The present invention relates to a composition comprising nonionic surfactants to enable favorable micelle formation and enhanced detergency in fabric treatment as well as processes of using such compositions.

### Description of the Prior Art

Detergency is defined as the effectiveness of a detergent in removing soil from surfaces in laundry operations. Dirt and stains contribute to the bulk of laundry soil, but accumulated soil like sebum is also a challenge of interest in the functionality of detergent. The efficiency of detergent is improved by modifying surfactant's micelle formation behavior. A micelle is typically defined as an aggregate of surfactant molecules dispersed in a liquid colloid, which enhances the cleaning process by trapping and isolating dirt and oils. Detergent industries typically seek formulations that offer weight-efficiency and volume-efficiency. Such formulations help to utilize resources more effectively.

Laundry detergents are chemical blends comprised of surfactants formulated to facilitate fabric cleansing. Surfactant molecules form micelles and engage soil while lifting soil off fabrics. In industrial and institutional (I&I) cleaning, laundry detergents' effectiveness determines the organization's cost of operation and energy efficiency. In household cleaning, ergonomics and effectiveness of laundry detergent can directly influence the cost and quality of living. For the public sector, the weight of detergent and dispersed use endpoint of laundry detergent builds logistical strain on transit and environmental burden typically in the form of wastewater treatment. As such, a favorable laundry detergent typically pursues superior stain removal capability, smaller volume or weight per dose, and ergonomic features including, for example, biodegradability, nonirritant skin contact, biodegradability, minimize fabric attrition, ease-of-use, etc.

The current state of the art in laundry detergent formulation is built around anionic surfactants for their micelle-forming behavior, foaming capability, and cost-effectiveness through economy of scale. Typical anionic surfactant choices for this purpose include, for instance, sodium lauryl sulfate (SLS) and sodium laureth sulfate (SLES). Though their associated formulations' stain removal capabilities in fabric treatment are well recognized, anionic surfactants can also damage the treated fabric through excessive surface tension, overwhelming foam can cause mechanical failure which needs to be counteracted in formulation with redundant defoaming agent, and poor rinsing in hard water can cause residue accumulation on machinery as well as garments. Also, anionic surfactants require either a bulk builder or solvent in formulation and hence result in excessive mass per dose, and the industrial synthesis of anionic surfactants generates carcinogenic byproduct hazardous to public health that has only recently been brought under regulation. Modern commercial and household uses demand laundry detergents to feature benefits beyond stain lifting, such as nonirritant skin contact and less environmental burden, expectations which anionic surfactant-based laundry detergents have failed to meet.

Nonionic surfactants, despite superior ergonomics and milder environmental impact, are not considered to be favorable material for detergency when compared with anionic surfactants. The uncharged hydrophilic and hydrophobic group of nonionic surfactants have been utilized in laundry detergent formulations as anionic surfactants' supporting material to modify the formula's wetting, emulsification, and foaming behaviors, but their stain lifting capability is typically considered insufficient because of unfavorable micelle formation behavior due to lacking charge disparity between the hydrophilic and hydrophobic group.

Several examples using the non-ionic surfactants have been disclosed in the past. One such example is disclosed in a Research Publication entitled “POLYMER-SURFACTANT INTERACTIONS”, by R. Nagarajan. Nagarajan discloses surfactants and polymers used in detergent formulations. The interactions between polymers and surfactants in aqueous media give rise to the formation of association structures, thereby modifying the solution and interfacial properties. The morphologies of association complexes depend on the molecular properties of the polymer and the surfactant. In this paper, the author examines in detail, the association structure that forms in the presence of non-ionic polymers, based on a quantitative theory. The author shows that a variety of experimental observations are suggestive of the proposed structure of the complex. Then a detailed thermodynamic treatment is formulated to examine the competition between the formation of polymer-free surfactant aggregates and polymer-surfactant association complexes. The molecular features controlling this competition are identified to be the steric interactions between surfactant head groups and polymer segments, the shielding of micelle-water contact by the polymer, and the polymer hydrophobicity. The theory is used to explain why the presence of the polymer lowers the critical micelle concentration, reduces the size of spherical micelles, allows formation of complexes with mixed surfactants, and transforms large rod-like micelles and vesicles into smaller globular micellar aggregates. We conclude by alluding to the impact of the polymer on other properties such as solubilization and microemulsification.

Another example is disclosed in an Australian Publication No. 2019204219, entitled “Detergent composition” (“the '219 Publication”). The '219 Publication discloses a liquid hard surface detergent composition comprising a liquid mixed alkoxylate fatty alcohol non-ionic surfactant comprising a greater number of the lower higher alkoxylate group than the higher alkoxylate group in the molecule and a builder. The compositions provide good shine/anti-spotting characteristics on hard surfaces and are especially suitable for use as automatic dishwashing compositions.

Yet another example is disclosed in a Research Publication entitled “Effects of functional group of non-ionic surfactants on the stability of emulsion”, by Kesan Perbezaan et. al. Kesan discloses three mixed blend non-ionic surfactants: fatty acid polyethoxylates (POE) (20), POE (20) sorbitan monooleate (or Tween 80) and fatty alcohol POE (25) bounded by 20-25 moles of ethylene oxides (EO) mixed with Laureth-1 chosen to analyze their different functional group and its properties to the emulsion.

Considering the above, it is desirable to use non-ionic surfactant with polymer to enable favorable micelle formation and grant non-ionic surfactant superior detergency in laundry operation.

### SUMMARY OF THE INVENTION

It is an object of the present invention to provide superior detergency by leveraging the synergistic interaction between (same or different) non-ionic surfactants and polymers.

It is another object of the present invention to provide a composition comprising non-ionic surfactants that enables favorable micelle formation and enhanced detergency in fabric treatment as well as processes for using such compositions.

It is another object of the present invention to provide a composition of at least one non-ionic surfactant and at least one polymer, in which the polymer can be blended with the surfactant(s) OR aggregated as a copolymer in the molecular structure of the surfactant(s).

It is another object of the present invention to provide a favorable non-ionic surfactant micelle formation behavior under typical laundry conditions, such as in hand-washing laundry, washing machine, and in hot, cold, or hard water.

It is another object of the present invention to achieve the formation of a favorable micelle structure through the combination of a non-ionic surfactant pre-bonded with a polymer, and at least one other non-ionic surfactant that exhibits superior cleaning capabilities.

It is another object of the present invention to obtain more cleaning capabilities while reducing the weight of detergents.

In order to overcome the limitations here stated, the present invention discloses a method of combining non-ionic surfactant with polymers and additional non-ionic surfactants for forming a micelle in order to enhance non-ionic surfactant detergency performance. The method includes selecting ethoxylated alcohol as a primary non-ionic surfactant. The primary non-ionic surfactant is mixed with a polymer such as cellulose (C6H10O5)n, polyethyleneimine ethoxylate, and alkoxylated polyethyleneimine. The polymer is uniformly integrated/bonded into the primary non-ionic surfactant, forming a stable primary non-ionic surfactant polymer aggregate. The primary non-ionic surfactant polymer aggregate is then mixed with a secondary non-ionic surfactant in a ratio ranging from 10:1 to 1:20. In one example, the secondary non-ionic surfactant has the same composition to that of the primary non-ionic surfactant. In another example, the secondary non-ionic surfactant has a different composition from the primary non-ionic surfactant. This helps to have assorted/different non-ionic surfactants that can be mixed with polymer. The mixture is used for forming a micelle structure that enhances detergency performance. The detergent formulation has applications in various cleaning products, including laundry detergents, dishwashing liquids, and surface cleaners.

In one advantageous feature of the present invention, the detergent formulation achieves superior cleaning performance by leveraging the favorable micelle formation characteristics of non-ionic surfactant-polymer aggregates in combination with additional non-ionic surfactants. The detergent formulation achieves approximately 10% more cleaning power at approximately 90% less weight than a traditional detergent.

In another advantageous feature of the present invention, the detergent formulation minimizes or avoids the reliance on potentially hazardous anionic surfactants while promoting sustainability and reducing adverse effects on aquatic life and irritation to human skin.

In another advantageous feature of the present invention, the detergent formulation offers a comparable or superior stain removal capability when compared to a greater amount of an anionic surfactant blend, thereby reducing the amount of laundry detergent needed for similar laundry needs.

In another advantageous feature of the present invention, the detergent formulation avoids anionic surfactants, thereby reducing reliance on materials (e.g., SLS and SLES) that generate 1,4-diaoxane under industrial setting. This avoidance makes the manufacturing process more efficient, as a plant does not need to invest in purging and stripping the carcinogen from the product. This also makes society healthier, as consumer products are not contaminated with the carcinogen.

In another advantageous feature of the present invention, the detergent formulation enables the creation of nonirritant laundry detergent products. Here, the non-ionic surfactants are uncharged and hence do not react as reactively with skin as their anionic counterparts. While the non-ionic surfactants are usually classified as irritating hazardous materials, the presently disclosed composition can transform the surfactant blend into a non-irritant formulation and product, as supported by clinical test results.

In another advantageous feature of the present invention, the detergent formulation enables the creation of ergonomic products. For instance, a smaller required dosage and low viscosity allow the composition's formula to work with easy-to-use packaging, like bottles fitted with pumps, which meets end-user demand.

In another advantageous feature of the present invention, the lighter laundry detergent is easier to transport, requiring fewer trucks and ships for fulfillment. Further, the non-ionic surfactants are less hazardous to water bodies than anionic ones.

These and other objects of the present invention will be apparent from review of the following specification.

### DETAILED DESCRIPTION OF THE PREFERRED EMBODIMENT

The detailed description set forth below is a description of exemplary embodiments in which the presently disclosed invention may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed detergent formulation. However, it will be apparent to those skilled in the art that the presently disclosed invention may be practiced without these specific details. In some instances, well-known structures and compositions are shown in functional or conceptual form in order to avoid obscuring the concepts of the presently disclosed detergent formulation.

In the present specification, an embodiment showing a singular structure and composition should not be considered limiting. Rather, the invention preferably encompasses other embodiments including a plurality of the same structure and composition, and vice-versa, unless explicitly stated otherwise herein. Moreover, the applicant does not intend for any term in the specification to be ascribed an uncommon or special meaning unless explicitly set forth as such. Further, the present invention encompasses present and future known equivalents to the known structure and composition referred to herein by way of illustration.

Although the present invention describes a detergent formulation, it is to be further understood that numerous changes may arise in the details of the embodiments of the detergent formulation. It is contemplated that all such changes and additional embodiments are within the spirit and true scope of this invention.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the invention and are not intended to limit the scope of the invention.

In the context of the present invention, the term “fluid” includes liquid, gel, and paste product forms.

As used herein, “laundry detergent” means products formulated from surfactants and other ingredients formulated to facilitate fabric cleansing, including, but not limited to, powder laundry detergent, fluid laundry detergent, laundry detergent pods, spot treatments, pre-treatments, and laundry boosters.

In the context of the present invention, the terms “a” and “an” mean “at least one.”

As used herein, “blend” means a mixture of chemical substances in one or more phases.

As used herein, when a polymer is said to contain or comprise a monomer, it is understood that this is synonymous with a residue of such monomer.

The essence of the composition is to utilize the intermolecular interaction between the polymer blocks, either as polymer molecules or as copolymer aggregated with non-ionic surfactant molecules, to bind non-ionic surfactant molecules into spherical micelle structures with internal hydrophobic group and external hydrophilic group in aqueous environment. Hence, through polymer assisted favorable micelle formation, non-ionic surfactants have their detergency enabled in laundry setting.

This composition is different from a composition comprising only ionic surfactants as the ionic surfactant molecules, through gaining charge in aqueous environment, forms spherical micelle intermolecular structure reliant on intermolecular electronegativity disparity.

This composition is different from a composition comprising both ionic surfactant and non-ionic surfactant as the latter relies on the ionic surfactant molecule to first gain charge in aqueous environment and then bind with non-ionic surfactant before forming spherical micelle structure.

The present invention presents a method of enhancing detergency performance of non-ionic surfactants by forming favorable micelles through the incorporation of specific polymers and additional non-ionic surfactants. In other words, a primary non-ionic surfactant is combined with polymer and a secondary non-ionic surfactant.

The primary non-ionic surfactant includes an ethoxylated alcohol. In one example, ethoxylated alcohol has a formula of Cₓ—C_{γ}(C₂H₄O)ₙH (x=8-10, y=10-16, y>x, n=1-10). Here, the formula allows a range of surfactants with varying parameters. In this formula, “Cₓ—C_{y}” represents the hydrocarbon chain of the alcohol, where “x” and “y” are the numbers of carbon atoms. (C2H4O) represents the number of ethoxy groups, denoted by “n”. “H” represents the hydrogen atom attached to the terminal oxygen of the ethoxy group. In one example, “x” ranges from 8 to 10, representing the number of carbon atoms in the first part of the alkyl chain, and “y” ranges from 10 to 16, representing the number of carbon atoms in the second part of the alkyl chain. Here, y is greater than x, indicating a longer hydrophobic tail. Further, “n” ranges from 1 to 10 representing the number of ethylene oxide units. The number of ethylene oxide units affects the hydrophilicity of the surfactant. The varied ranges in the parameters presented above allow for precision-tuning of the surfactant's hydrophobic-hydrophilic balance (HLB). The HLB determines the surfactant's ability to form micelles and the size and shape of those micelles.

The polymer includes, but not limited to, cellulose (C6H10O5)n, polyethyleneimine ethoxylate, and alkoxylated polyethyleneimine. The cellulose is selected due to its biodegradability and ability to form strong interactions with surfactants. The polyethyleneimine ethoxylate is selected to enhance micelle stability and surfactant performance. Further, the alkoxylated polyethyleneimine is selected to improve aggregation properties with non-ionic surfactants.

The secondary non-ionic surfactant may or may not have the same composition as the primary non-ionic surfactant. In other words, the secondary non-ionic surfactant has the same composition to that of the primary non-ionic surfactant. Optionally, the secondary non-ionic surfactant has a different composition to that of the primary non-ionic surfactant.

In accordance with the present invention, at first, the primary non-ionic surfactant is mixed/bonded with the polymer. The polymer is uniformly integrated/bonded into the primary non-ionic surfactant, forming a stable primary non-ionic surfactant polymer aggregate. Subsequently, the primary non-ionic surfactant polymer aggregate is mixed with another non-ionic surfactant. For ease of reference, another non-ionic surfactant is referred to as the secondary non-ionic surfactant, as presented above.

In one example, the primary non-ionic surfactant polymer aggregate is mixed with the secondary non-ionic surfactant in a ratio ranging from 10:1 to 1:20. It should be understood that the above ratio of mixture is presented for illustrative purposes. The range of mixture may change depending on the cleaning performance required for the surfactant formulation. The mixing can be performed using conventional mixing techniques, such as stirring, shaking, or blending, to ensure a homogeneous mixture.

After mixing the primary non-ionic surfactant polymer aggregate with the secondary non-ionic surfactant, the detergent formulation forms a micelle structure that enhances detergency performance. In one example, the presently disclosed non-ionic surfactant-polymer detergent formulation exhibits approximately 10% more cleaning power than traditional detergents, when evaluated using the ASTM D4265 method. Additionally, the formulation requires approximately 90% less weight compared to traditional detergents, contributing to improved weight-efficiency and volume-efficiency.

The detergent formulation can be realized in four different composition scenarios. First, the formulation may include a primary non-ionic surfactant with an aggregated copolymer and a secondary non-ionic surfactant. Second, the formulation may include a primary non-ionic surfactant with an aggregated copolymer, a secondary non-ionic surfactant, and a polymer. Third, the formulation may comprise a primary non-ionic surfactant with an aggregated copolymer. Fourth, the formulation may comprise a primary non-ionic surfactant with an aggregated copolymer and a polymer. Each of the above scenarios may use ingredients from a pool of candidates from the following classes.

The non-ionic surfactant (primary non-ionic surfactant) with aggregated copolymer may include, but is not limited to, Ethoxylated alcohol (primary alcohol aggregated with ethylene oxide (EO)), and Alkoxylated alcohol (primary alcohol aggregated with EO and propylene oxide (PO), such as an EO/PO block copolymer unspecified). Here, Ethoxylated alcohol is made to undergo an ethoxylation reaction, which is also included in SLES synthesis for generating the 1,4-dioxane carcinogen byproduct. Since ethoxylated alcohol does not need to be treated with sulfuric acid or sulfur trioxide, the chance of 1,4-dioxane byproduct formation is reduced.

The non-ionic surfactant (secondary non-ionic surfactant) may include, but is not limited to, Lauryl glucoside, octyl glucoside, and sorbitan.

The polymer may include, but is not limited to, Cellulose, polyethyleneimine ethoxylate, and alkoxylated polyethyleneimine.

The present detergency formulation may be used in liquid or powder form depending on the desired application. The presently disclosed non-ionic surfactant-polymer detergent formulation can be used in various cleaning applications, including but not limited to, laundry detergents, dishwashing liquids, surface cleaning agents, industrial cleaning applications, household cleaning products, and in the automotive and transportation industries. The manufacturing technique (e.g., mixing method, temperature) should be obvious to any person skilled in the art to make and use the invention. The proportion of each component, carbon chain length, polymer chain length and size of copolymer blocks may vary depending on the end product needed, and all such possible modifications fall within the scope of the present invention.

The presently disclosed non-ionic surfactant polymer detergent formulation provides several advantages over prior art. For example, the non-ionic surfactant-polymer detergent formulation offers enhanced cleaning performance when compared to traditional non-ionic surfactant polymer mixture. The non-ionic surfactant polymer detergent formulation significantly reduces the environmental hazards associated with anionic surfactants. As a result, the non-ionic surfactant polymer detergent formulation is safe for aquatic life and less irritating to human skin. Further, the non-ionic surfactant polymer detergent formulation enhances cleaning performance by approximately 10% while reducing the weight of traditional detergents by about 90%.

A person skilled in the art appreciates that the detergent formulation may change depending on the need. Further, different materials in addition to or instead of materials/compositions/formulations described herein may also be used and such implementations may be construed to be within the scope of the present invention. Further, many changes in the composition may take place without deviating from the scope of the presently disclosed detergent formulation.

In the above description, numerous specific details are set forth such as examples of some embodiments, specific compositions, methods, in order to provide a thorough understanding of embodiments of the present invention. It will be apparent to a person of ordinary skill in the art that these specific details need not be employed, and should not be construed to limit the scope of the invention.

In the development of any actual implementation, numerous implementation-specific decisions must be made to achieve the developer's specific goals, such as compliance with formulation-related and business-related constraints. Various changes could be made in the above formulations without departing from the scope of the invention, it is intended that all matter contained in the above description shall be interpreted as illustrative and not in a limiting sense.

The foregoing description of embodiments is provided to enable any person skilled in the art to make and use the invention. Various modifications to these embodiments will be readily apparent to those skilled in the art, and the novel principles and invention disclosed herein may be applied to other embodiments without the use of the innovative faculty. It is contemplated that additional embodiments are within the spirit and true scope of the disclosed invention.

What is claimed is:

1. A detergent formulation, comprising:
a primary non-ionic surfactant;
a polymer blended integrated with said primary non-ionic surfactant to form a primary non-ionic surfactant-polymer aggregate; and
a secondary non-ionic surfactant mixed with said primary non-ionic surfactant-polymer aggregate,
wherein said detergent formulation forms a micelle structure in an aqueous environment to provide detergency.

2. The detergent formulation of claim 1, wherein said primary non-ionic surfactant comprises an ethoxylated alcohol.

3. The detergent formulation of claim 2, wherein said ethoxylated alcohol has a formula Cₓ—C_{γ}(C₂H₄O)ₙH, where x ranges from 8 to 10, y ranges from 10 to 16, y is greater than x, and n ranges from 1 to 10.

4. The detergent formulation of claim 1, wherein said polymer is selected from a group consisting of cellulose, polyethyleneimine ethoxylate, and alkoxylated polyethyleneimine.

5. The detergent formulation of claim 1, wherein said secondary non-ionic surfactant has a composition identical to said primary non-ionic surfactant.

6. The detergent formulation of claim 1, wherein said secondary non-ionic surfactant has a composition different from said primary non-ionic surfactant.

7. The detergent formulation of claim 6, wherein said secondary non-ionic surfactant is selected from a group consisting of Lauryl glucoside, octyl glucoside, and sorbitan.

8. The detergent formulation of claim 1, wherein said primary non-ionic surfactant-polymer aggregate and said secondary non-ionic surfactant are in a ratio ranging from 10:1 to 1:20.

9. The detergent formulation of claim 1, wherein said detergent formulation is free of anionic surfactants.

10. The detergent formulation of claim 1, wherein said detergent formulation is provided in a form selected from a group consisting of a liquid, a powder, a gel, and a paste.

11. A method of producing a detergent formulation, said method comprising the steps of:
selecting a primary non-ionic surfactant;
selecting a polymer;
mixing said primary non-ionic surfactant and said polymer to form a primary non-ionic surfactant-polymer aggregate;
selecting a secondary non-ionic surfactant; and
mixing said primary non-ionic surfactant-polymer aggregate and said secondary non-ionic surfactant for forming a micelle structure in an aqueous environment to produce said detergent formulation.

12. The method of claim 11, further comprising mixing said primary non-ionic surfactant-polymer aggregate and said secondary non-ionic surfactant in a ratio ranging from 10:1 to 1:20.

13. The method of claim 11, wherein said primary non-ionic surfactant comprises an ethoxylated alcohol.

14. The method of claim 13, wherein said ethoxylated alcohol has a formula Cₓ—C_{γ}(C₂H₄O)ₙH, where x ranges from 8 to 10, y ranges from 10 to 16, y is greater than x, and n ranges from 1 to 10.

15. The method of claim 11, wherein said polymer is selected from a group consisting of cellulose, polyethyleneimine ethoxylate, and alkoxylated polyethyleneimine.

16. The method of claim 11, further comprising selecting said secondary non-ionic surfactant having a composition identical to said primary non-ionic surfactant.

17. The method of claim 11, further comprising selecting said secondary non-ionic surfactant having a composition different from said primary non-ionic surfactant.

18. The method of claim 11, wherein said secondary non-ionic surfactant is selected from a group consisting of Lauryl glucoside, octyl glucoside, and sorbitan.

19. The method of claim 11, further comprising providing said detergent formulation in a form selected from a group consisting of a liquid, a powder, a gel, and a paste.

20. The method of claim 11, further comprising mixing said primary non-ionic surfactant-polymer aggregate and said secondary non-ionic surfactant comprises at least one technique selected from the group consisting of stirring, shaking, and blending.
